(19) United States
(12) Patent Application Publication
(10) Pub. No.: US 2010/0043611 A1
(43) Pub. Date: Feb. 25, 2010

(54) METHOD OF OPTIMIZING PROCESSING OF SUCCESSIVE WORKPIECES THROUGH CUTTING MACHINES

(75) Inventors: Ronald Pobuda, Salmon Arm (CA); Sandy Webster, Salmon Arm (CA); Brian Stroud, Salmon Arm (CA); Roland Davyduke, Salmon Arm (CA)

Correspondence Address: Schwabe Williamson & Wyatt;PACWEST CENTER, SUITE 1900, 1211 SW FIFTH AVENUE, PORTLAND, OR, 97204, US

(73) Assignee: USNR/Kockums Cancary Company, Vancouver, WA (US)

(21) Appl. No.: 12/607,014

(22) Filed: Oct. 27, 2009

Related U.S. Application Data
(62) Division of application No. 11/095,583, filed on Apr. 1, 2005, now abandoned.

(51) Int. Cl. B26D 3/00

(52) U.S. Cl. 83/42

(57) ABSTRACT

A method of optimizing processing of successive workpieces through cutting machines, includes the steps of determining and optimizing a first cut pattern for a preceding workpiece infeeding into an active cutting device, determining and optimizing a second cut pattern for a succeeding workpiece succeeding the preceding workpiece infeeding into the cutting device, synchronizing the preceding workpiece with the active cutting device such that the active cutting device is pre-positioned to achieve an optimized first cut pattern of the preceding workpiece prior to the preceding workpiece engaging the active cutting device, processing through the cutting device the preceding workpiece according to the first cut pattern; adjusting an infeed gap between the preceding workpiece and the succeeding workpiece so that the active cutting device has sufficient time to pre-position to achieve the optimized second cut pattern of the succeeding workpiece prior to the active cutting device engaging the succeeding workpiece.

### FIELD OF THE INVENTION

This invention relates to the field of lumber manufacturing and in particular, it relates to a method for optimizing processing of successive lumber workpieces in through lumber processing machinery, and in particular cutting machines, by selectively adjusting the gap between the workpieces according to an optimized or re-optimized cutting and gapping solution.

### BACKGROUND OF THE INVENTION

During the lumber manufacturing process, stems of wood, logs, cants, flitches, and other lumber workpieces are transported through various primary and secondary break down and processing systems, such as debarkers, merchandisers, edgers, and planers. Prior to being processed, workpieces are typically transported downstream along various log handling systems, such as a conveyor or feeder, before the workpieces make contact with the cutting devices of a workpiece processing system. For example, a stem of wood may be advanced downstream on a conveyor through a log merchandiser or log bucking system such that the stems may be processed by head saws into logs of predetermined lengths. As a further example, flitches may be transported along a feeder and through an edger to produce longitudinal planks having smooth parallel edges.

Productivity of the workpiece processing systems is governed mainly by the gap between successive workpieces. If the gap is kept to a minimum, the processing system may process a greater number of workpieces, thereby increasing throughput and productivity.

Typically, in lineal scanning systems workpieces are transported end to end lengthwise along the conveyor or feeder of a workpiece processing system such that the workpieces may be linearly scanned, optimized, and the workpiece and cutting devices positioned relative to one another according to an optimized cutting solution. Processing systems known in the art require gaps between successive workpieces to allow the positioners of the workpieces and/or cutting devices to re-adjust and re-position the workpieces and/or cutting devices after processing a workpiece prior to engaging and processing a subsequent workpiece. The cutting devices and/or workpieces are positioned according to an optimized cut pattern based on the optimized cutting solution. Typically, a scanner scans successive workpieces positioned on a conveyor of a processing system to determine the shape including curvature, grade, etc of the workpiece and an optimizer determines an optimized cutting solution specific to each of the scanned workpieces. A processor then determines an optimized cut pattern for the cutting devices based on the optimized cutting solution and transmits such information to the positioners of the cutting devices so that the cutting devices may be positioned prior to processing each workpiece. After processing each workpiece, the cutting devices while being positioned wait before commencing the next optimized cut pattern based on the optimized cutting solution of the following workpiece while the conveyor continues to run. This requires an increased gap between successive workpieces. The problem with this gapping is that the productivity of the workpiece processing system is unnecessarily compromised. Large gaps between successive workpieces lower the throughput of the workpiece processing system, thereby lowering the volume of production.

As a result, there exists a need in the lumber manufacturing industry for a method of reducing gaps between successive workpieces on a conveyor or feeder of a workpiece processing system such that the throughput of the workpiece processing system may be increased.

### SUMMARY OF THE INVENTION

The present invention reduces the gap between successive workpieces by modifying the optimized cutting solution or the optimized cut pattern between successive workpieces such that re-adjustment and re-positioning of the cutting devices between successive workpieces may be mninimized, thereby reducing the gap required between the workpieces. The gap between successive workpieces may also be reduced by transmitting the optimized cut pattern of a succeeding workpiece to the positioner of the cutting device before the cutting device completes processing a preceding workpiece such that the cutting device may commence to re-adjust and re-position shortly before or as soon as the cutting device completes processing the preceding workpiece.

In accordance with the present invention, there is provided a method of adjusting gaps between successive workpieces on a workpiece processing system wherein the method includes the steps of synchronizing a preceding workpiece with an active cutting device such that the active cutting device may be pre-positioned according to a first cut pattern of the preceding workpiece prior to the preceding workpiece engaging the active cutting device; processing the preceding workpiece according to the first cut pattern; pre-positioning the active cutting device according to a succeeding cut pattern of a succeeding workpiece prior to the active cutting device engaging the succeeding workpiece; and synchronizing the succeeding workpiece to engage the active cutting device after the active cutting device completes processing the preceding workpiece. Preferably, the workpiece processing system includes a processor, which may be separate from or include an optimizer, for determining an optimized cutting solution and optimized cut pattern specific to each of the successive workpieces. The optimized cut pattern of the succeeding workpiece may then be transmitted to the positioner of the cutting device before the cutting device completes processing the preceding workpiece such that the cutting device may be pre-positioned according to a succeeding optimized cut pattern prior to processing the succeeding workpiece.

In one embodiment of the invention, the optimizer determines an optimized cutting solution for each of the successive workpieces and the processor determines an optimized cut pattern based on the optimized cutting solution. The optimized cut pattern may be transmitted to the positioners of the cutting device before the cutting device exits the workpiece being processed and the cutting device may be immediately adjusted and positioned for example slightly before or as soon as the cutting device completes processing and exits the preceding workpiece. The ability to immediately re-adjust and re-position the cutting device therefore reduces the gap between successive workpieces. The immediate re-adjustment and re-positioning also eliminates time lost waiting for the next succeeding optimized cut pattern to be transmitted to the positioner of the cutting device and the ensuing transition time to adjust the cutting device. As such, productivity and throughput of the workpiece processing system may be increased without compromising recovery. Thus, the succeeding optimized cut pattern may be transmitted to the positioner of the cutting device such that the cutting device may begin adjusting and positioning according to the succeeding optimized cut pattern of the succeeding workpiece during the cutting device exiting, that is, as the cutting device begins to exit the preceding workpiece where a characteristic such as blade flexibility allows the processor to assess and balance the amount of re-adjustment and re-positioning required between successive workpieces and determine if the cutting device may be able to withstand some or all of the required re-adjustment and re-positioning before the cutting device exits the preceding workpiece. The ability to re-adjust and re-position the cutting device before the cutting device completes processing the preceding workpiece enables the cutting device to begin processing the succeeding workpiece according to the succeeding optimized cut pattern sooner, for example immediately, thereby significantly reducing or even eliminating the gap between the successive workpieces. As such, productivity and throughput of the workpiece processing system may be increased without significantly or at all compromising recovery.

In another embodiment of the invention, prior to the cutting device engaging and processing the workpieces, the optimizer compares the optimized cutting solution of the preceding workpiece with the optimized cutting solution of the succeeding workpiece. The processor may decide to modify the cut pattern of either the preceding or the succeeding workpiece or both such that minimal or no re-adjustment or re-positioning of the cutting device is required between the lead-out segment and the lead-in segment of the successive workpieces. As such, the gap between the successive workpieces may be significantly reduced or eliminated, thereby increasing throughput of the workpiece processing system. The decision to modify the cut pattern of either the preceding or succeeding workpiece depends on the impact the decision has on recovery.

In yet another embodiment of the invention, prior to the cutting device engaging and processing the workpieces, the optimizer compares the optimized cutting solution of the preceding workpiece with the optimized cutting solution of the succeeding workpiece. The optimizer may then re-optimize either the preceding or succeeding workpiece or both to re-adjust the optimized cutting solution such that adjustments of the cutting devices between successive workpieces are minimal. As such, successive workpieces may be positioned very closely together such that the gap between the workpieces may be significantly reduced or even eliminated, thereby increasing the productivity and throughput of the workpiece processing system. The decision to re-optimize either the preceding or succeeding workpiece depends on the impact the decision has on recovery.

Preferably, the processor may be provided with wood value inputs such that the processor may compute and assess the costs and benefits of valuing volume or recovery, given the value inputs. The present invention may apply to straight sawing systems, curve sawing systems, or any workpiece processing system wherein the cutting devices are constantly re-adjusted and re-positioned between successive workpieces.

In summary, to further reduce the gap; start moving the cutting tools before the log end. Change the solution at the end of one log and/or the beginning of the next log to reduce the cutting tool travel. As the log costs reduce due to bug kill, at some point output is more valuable than recovery. Then more radically change end solutions if the value of increased lumber volume is worth more than the recovery loss. This would be an optimizer decision with a sliding scale input, by the user, between maximum value and volume.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1a is, in perspective view, a schematic representation of a typical curve sawing system.

FIG. 1b is a diagrammatic view illustrating conventional use of gaps between workpieces.

FIG. 1c depicts a prior method of processing of successive workpieces.

FIG. 2 is a flow chart depicting a first embodiment of the method of reducing gaps between successive workpieces according to the present invention;

FIG. 3 is a flow chart depicting a second embodiment of the method of reducing gaps between successive workpieces according to the present invention;

FIG. 4 is a flow chart depicting a third embodiment of the method of reducing gaps between successive workpieces according to the present invention; and

FIG. 5 is a flow chart depicting a fourth embodiment of the method of reducing gaps between successive workpieces according to the present invention.

### DETAILED DESCRIPTION OF EMBODIMENTS OF THE INVENTION

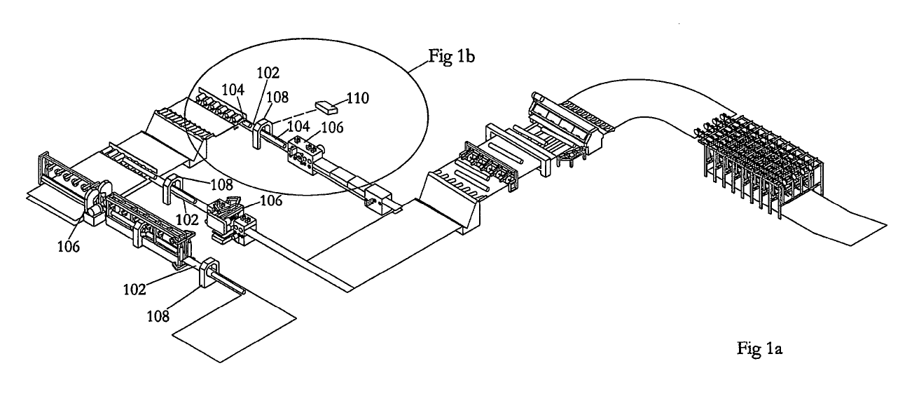

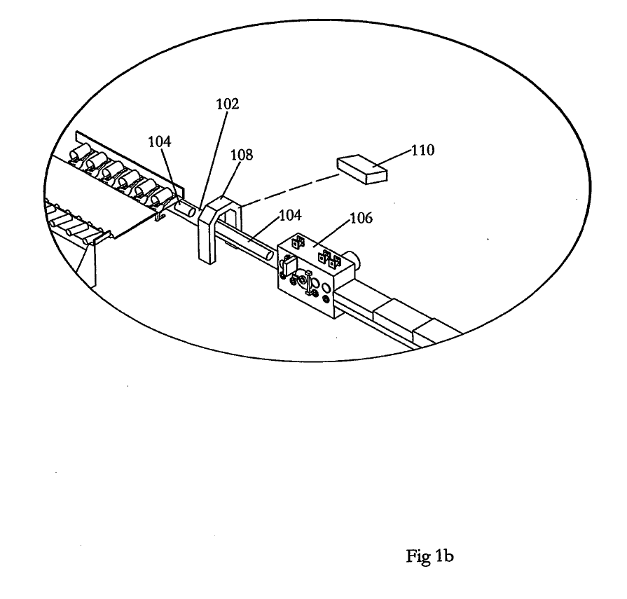

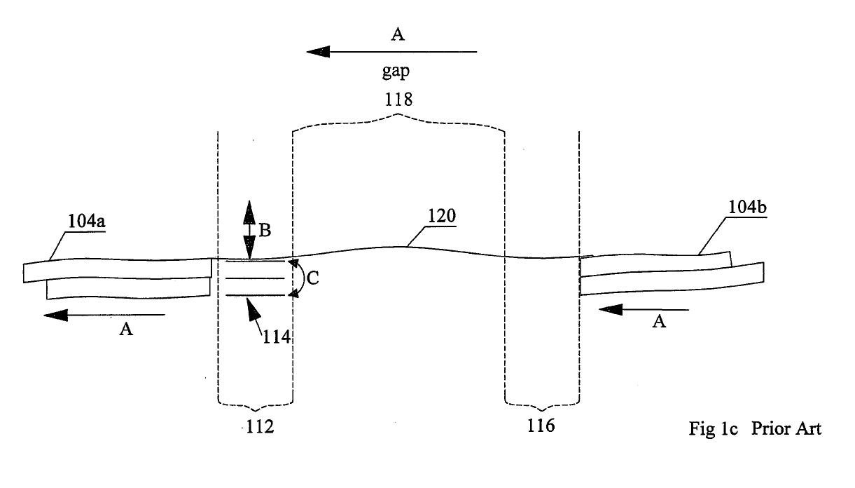

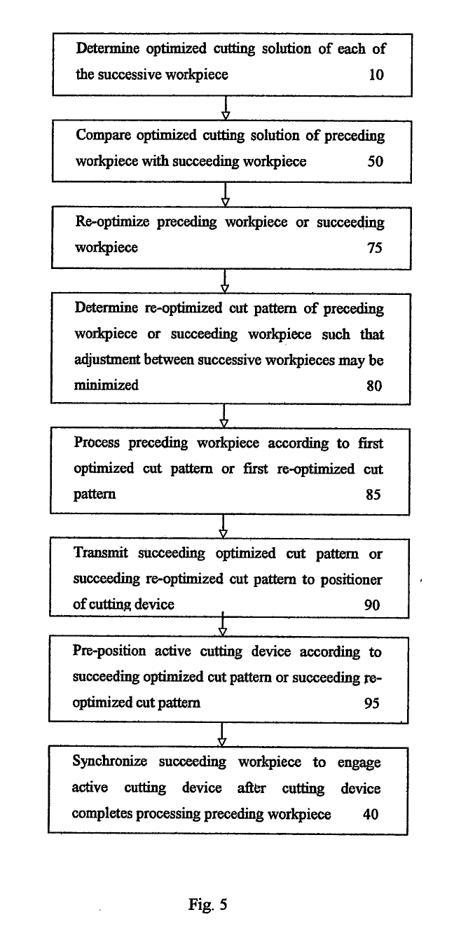

In FIGS. 1a, 1b and 5 similar characters of reference denote corresponding parts or steps in each view. The method of optimizing processing of successive or subsequent workpieces according to the present invention is practiced on, for example, a workpiece processing system, such as that of a sawmill illustrated by way of example in FIG. 1a having a conveyor or feeder 102 (better seen in FIG. 1b) for transporting successive workpieces 104 endwise downstream towards cutting devices 106 for processing the workpieces. Preferably, the workpiece processing system also includes a scanner 108 and a processor 110 collectively including an optimizer and programmable logic controller (PLC). A workpiece processing system is herein defined as any lumber processing machinery including but not limited to merchandising systems, primary and secondary breakdown systems, trimmer systems, and planing systems. The scanner of the workpiece processing system scans a workpiece positioned on the conveyor such that the shape and curvature of the workpiece may be determined. The optimizer determines a cutting solution specific to the scanned workpiece. The scanner and optimizer successively and continuously scans and optimizes, respectively, the workpieces on the conveyor of the workpiece processing system. Preferably, the optimizer determines an optimized cutting solution for each workpiece.

The optimized cutting solution may then be transmitted to a processor which determines an optimized cut pattern based on the optimized cutting solution for the cutting device to process the workpiece. The cutting device described herein includes, but not limited to, band saws, gang saws, edgers, and planers. The processor transmits the optimized cut pattern to the positioner of the cutting device such that the cutting device may be pre-positioned or pre-set according to the optimized cut pattern prior to processing the workpiece. Preferably, the cutting device is selectively active such that cutting device motion may be started prior to the workpiece engaging the cutting device.

Typically, the cutting device has a lead-out segment 112 at the upstream end of each workpiece 104 relative to direction of translation A. As the cutting device 106 finishes cutting, for example sawing, a preceding workpiece 104a exit the blades 114 from the workpiece through the lead-out segment 112. The cutting device also has a lead-in segment 116. As the cutting device positions 118 to engage and process the subsequent or succeeding workpiece 104b by slewing and/or skewing in directions B and C respectively. In the prior art, there is a gap 118 between the lead-out 112 and the lead-in 116 segment to allow the cutting devices 106 to be positioned according to the cut pattern 120 of the succeeding workpiece 104b. Typically, after the cutting device 106 completes the lead-out 112 segment of the preceding workpiece 104a and exits the preceding workpiece 104a, the cutting device may slow as the positioner of the cutting device waits for the processor to transmit the motion instructions for the optimized cut pattern for the succeeding workpiece 104b. In the gap between the workpieces, the cutting device re-adjusts and re-positions and the cutting device re-accelerates to processing speed to process the succeeding workpiece. In the prior art, in the case of curve sawing, the saws are fixed at a target, generally a ‘worse case’ scenario. The saws continue following the target cam until after exiting the cant, and then motion stops. The saws then get PLC instructions for the next, that is succeeding, cant and reset to their new position. The saws then start on their new target ahead of the next cant.

In the present invention the optimized cut pattern of a succeeding workpiece 104b is transmitted to the positioner of the cutting device before the cutting device completes processing a preceding workpiece 104a. This allows the cutting device to immediately re-adjust and re-position as soon as, or even slightly before, the cutting device completes cutting through the preceding workpiece, thereby reducing or eliminating the gap between successive workpieces. Furthermore, by considering the optimized cutting solution or the optimized cut pattern of the succeeding workpieces, the optimizer or the processor may decide to modify the optimized cutting solution or the optimized cut pattern as further discussed below such that the cutting devices require minimal re-positioning between successive workpieces, thereby reducing or eliminating the gap between successive workpieces.

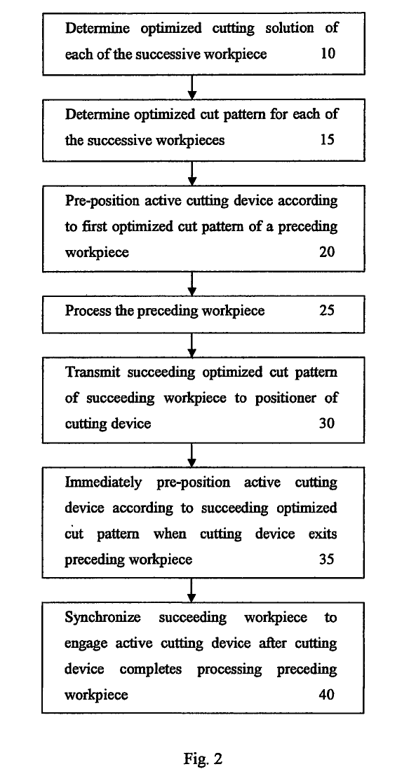

In a first method of the present invention, not intended to be limiting, and as illustrated in FIG. 2, in a first step the optimizer determines an optimized cutting solution for successive workpieces independent of the optimized cutting solution of the preceding or next subsequent (that is, first subsequent) workpiece 10. The processor independently determines an optimized cut pattern for the cutting devices based on the optimized cutting solution of each of the workpieces 15. Prior to processing the first or preceding workpiece, the cutting device motion is started and the cutting device is pre-positioned according to a first optimized cut pattern of the preceding workpiece 20. While the preceding workpiece 25 is being processed, the optimized cut pattern is transmitted to the positioners of the cutting device before the cutting device completes the lead-out segment of the workpiece 30 being processed so that the cutting device may immediately begin to re-adjust and re-position as soon as the cutting device completes the lead-out segment of the preceding workpiece 35. The size of the gap is adjusted, for example by adjusting the infeed speed, so that the succeeding workpiece is synchronized to engage the active cutting device after the cutting device completes processing the preceding workpiece and has immediately thereafter pre-positioned according to the succeeding optimized cut pattern 40. The ability to immediately re-adjust and re-position the cutting devices therefore reduces the gap required between subsequent workpieces and eliminates the deceleration and re-acceleration of the cutting device at the lead-out and lead-in segments, respectively. In addition, time lost waiting for the next optimized cut pattern to be transmitted to the positioners of the cutting device and the time lost between the deceleration and acceleration of the cutting device in between the lead-out segment and lead-in segment may also be eliminated, thereby increasing the productivity and throughput of the workpiece processing system without compromising recovery in favour of volume.

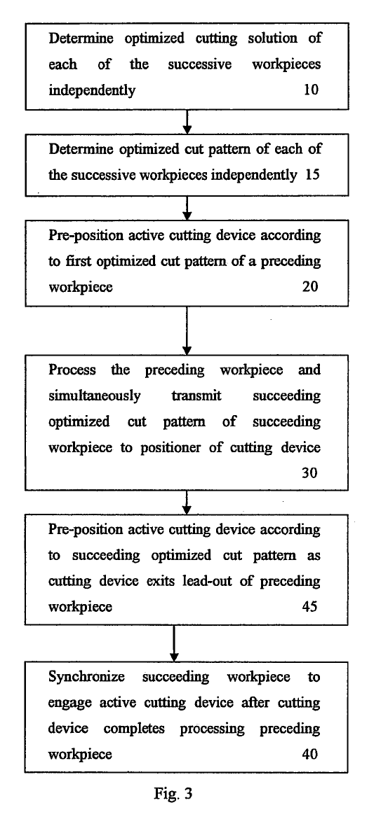

In a second embodiment of the method according to the present invention, as illustrated in the flow chart of FIG. 3 the optimizer determines an optimized cutting solution for successive workpieces independent of the optimized cutting solution of the preceding or subsequent next (that is, first subsequent) workpiece 10. The processor independently determines the optimized cut pattern to be followed by the cutting devices for each of the workpieces 15. Prior to processing the preceding workpiece, the cutting device motion is started and the cutting device is pre-positioned according to a first optimized cut pattern of the preceding workpiece 20. While the preceding workpiece is being processed 25, the optimized cut pattern of the succeeding workpiece is transmitted to the positioners of the cutting device before the cutting device completes the lead-out segment of the workpiece being processed 30 such that the cutting device may begin re-adjusting and re-positioning according to the succeeding optimized cut pattern of the subsequent workpiece as the cutting device begins to exit the workpiece 45. If the processor determines that the re-adjustment and re-positioning of the cutting devices between the preceding workpiece and the subsequent workpiece is minimal, the positioners of the cutting device begin to re-adjust and re-position the cutting device according to the succeeding optimized cut pattern at the lead-out segment as the cutting device begins to exit the preceding workpiece but is still processing the preceding workpiece. Because of the inherent flexibility of the cutting devices, although limited, for example the available, although limited, bending of saw blades, the processor may assess and balance the available flexibility of the cutting devices with the amount of re-adjustment and re-positioning required between the successive workpieces to determine if the cutting device may be able to withstand the bending required for re-adjustment and re-positioning while the cutting device is still engaging the preceding workpiece before or at the lead-out segment. By beginning the re-adjustment and re-positioning of the cutting devices before the cutting device completes processing the preceding workpiece, the cutting device may be pre-positioned in whole or in part according to the succeeding optimized cut pattern as the cutting device exits the preceding workpiece such that the succeeding workpiece may be synchronized to engage the active cutting device very shortly or immediately after the cutting device completes processing the preceding workpiece 40. The gap between successive workpieces may thereby be significantly reduced or eliminated. As such, productivity and throughput of the workpiece processing system may be increased without compromising recovery.

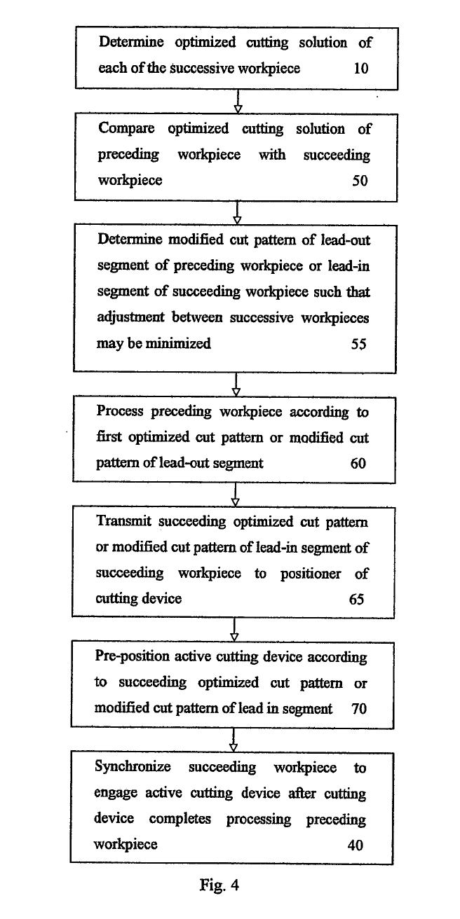

In the third embodiment of the method according to the present invention, as set out in the flow chart of FIG. 4, prior to the cutting devices engaging and processing the workpieces, the optimizer compares the optimized cutting solution of the preceding workpiece with the optimized cutting solution of the succeeding workpiece 50 to determine a modified cut pattern. Preferably, the modified cut pattern is merely a modification of just the lead-in segment of the succeeding workpiece or just the lead-out segment of the preceding segment, or of both lead-in and lead-out segments such that adjustments between the successive workpieces may be minimized 55. The processor may decide to process the first workpiece according to the optimized cut pattern for that workpiece, but may decide to process the subsequent workpiece according to a modified cut pattern of the lead-in segment such that minimal or no re-adjustment or re-positioning of the cutting devices is required to adjust the optimized cut pattern of the preceding workpiece to the modified cut pattern of the subsequent workpiece 60. Alternatively, the processor may decide to process the preceding workpiece according to a modified cut pattern of the lead-out segment and process the subsequent workpiece according to the optimized cut pattern such that the adjustment of the cutting devices between the preceding workpiece and the subsequent workpiece may be reduced. In the further alternative, the processor may decide to process both the preceding and the succeeding workpieces according to a modified cut pattern. The decision to modify the cut pattern of the preceding workpiece alone, or of the succeeding workpiece alone, or of both workpieces depends on the impact the decision has on optimizing recovery. Similar to the previous embodiments, the optimized cut pattern or the modified cut pattern of the lead-in segment of the succeeding workpiece is transmitted to the positioners of the cutting device before the cutting device completes the lead-out segment of the preceding workpiece 65 such that the cutting device may begin adjusting and pre-positioning according to the succeeding optimized cut pattern or modified cut pattern of the lead-in segment 70. Because of the minimal or lack of re-adjustment or re-positioning of the cutting devices between successive workpieces, the size of the gap between successive workpieces may be significantly reduced or eliminated, thereby increasing throughput of the workpiece processing system. However, because the modified cut pattern may differ from the optimized cut pattern, recovery may be compromised in favour of enhanced productivity.

In the fourth embodiment of the method according to the present invention, as set out in the flow chart of FIG. 5, prior to the cutting devices engaging and processing the workpieces, the optimizer compares the optimized cutting solution of the preceding workpiece to be processed with the optimized cutting solution of the succeeding workpiece 50. The optimizer may then re-optimize the preceding workpiece 75 and process the preceding workpiece according to a re-optimized cut pattern 80 such that the cutting devices require minimal or no positioning between successive workpieces 85. Alternatively, the preceding workpiece may be processed according to the optimized cut pattern for that workpiece while the optimizer re-optimizes for the succeeding workpiece 75 to determine a re-optimized cutting solution such that the cutting devices require minimal or no positioning between successive workpieces 80. Whether or not the preceding workpiece or the succeeding workpiece is re-optimized, the optimized cut pattern or the re-optimized cut pattern of the succeeding workpiece is transmitted to the positioner of the cutting device before the cutting device completes the lead-out segment of the preceding workpiece 90 such that the cutting device may begin adjusting and pre-positioning according to the optimized cut pattern or the re-optimized cut pattern of the succeeding workpiece 95. Given the minimal re-adjustment required, successive workpieces may be positioned very closely together such that the gap between successive workpieces may be significantly reduced or even eliminated, thereby increasing the productivity and throughput of the workpiece processing system. The decision to re-optimize a particular workpiece depends on the impact the decision has on recovery. Because the re-optimized cutting solution may differ from the optimized cutting solution, recovery may be compromised in favour of enhanced productivity.

Although the reduction or elimination of gaps between successive workpieces may compromise wood volume recovery in favour of increased throughput, in cases where wood costs are low, it may be advantageous to sacrifice recovery in the interest of increasing volume. However, if wood costs increase, interest in preserving high recovery at the expense of increased gaps and lower productivity may be warranted. In an embodiment of the present invention, the optimizer may be provided with wood value inputs such that the optimizer may compute and assess the costs and benefits of valuing volume or recovery, given the value inputs. For example, the value inputs may bias the optimizer towards limiting the gap reduction and cut pattern or cutting solution modification in favour of increasing recovery as opposed to increasing throughput due to the increased costs of wood.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1-20. (canceled)

21. A method of reducing gaps between successive workpieces in a processing system, the method comprising:
determining a first optimized cutting solution for a first workpiece and a second optimized cutting solution for a second workpiece;
comparing the first optimized cutting solution and the second optimized cutting solution;
determining a modified cut pattern for at least one of the first workpiece and the second workpiece based at least in part on said comparing; and
sending the modified cut pattern to the cutting device for processing of said at least one of the first workpiece and the second workpiece according to the modified cut pattern.

22. The method of claim 21, wherein the modified cut pattern minimizes repositioning of the cutting device between said first workpiece and said second workpiece.

23. The method of claim 21, wherein the comparing the cutting solutions includes comparing a portion of the first optimized cutting solution corresponding to a lead-out segment of the first workpiece to a portion of the second optimized cutting solution corresponding to a lead-in segment of the second workpiece.

24. The method of claim 21, wherein the determining is at least partially based on one or more wood value inputs.

25. The method of claim 24, wherein the determining comprises assessing at least one of production volume and wood recovery based at least in part on said one or more wood value inputs.

26. The method of claim 21, wherein the modified cut pattern includes at least one of a modified lead-in segment of the second workpiece and a modified lead-out segment of the first workpiece.

27. The method of claim 22, further comprising determining an additional optimized cutting solution for the second workpiece based on said comparing, the modified cut pattern being based on the additional optimized cutting solution for the second workpiece.

28. The method of claim 22, wherein the modified cut pattern is sent to the cutting device while the cutting device processes the first workpiece.

29. The method of claim 21, further comprising synchronizing the first and second workpiece to minimize a gap between the first and the second workpiece, wherein the first and second workpieces are fed sequentially into the cutting device by a conveyor, the second workpiece engaging the cutting device after processing of the first workpiece by the cutting device is completed.

30. The method of claim 29, wherein said synchronizing comprises adjusting conveyor speed.
